(19) United States
(12) Patent Application Publication
(10) Pub. No.: US 2023/0407829 A1
(43) Pub. Date: Dec. 21, 2023

(54) DEVICES, SYSTEMS, AND METHODS FOR ORIENTING FUEL INJECTOR NOZZLE SPRAY HOLES

(71) Applicant: Cummins Inc., Columbus, IN (US)

(72) Inventors: Ross A. Phillips, Columbus, IN (US); Jordan Patrick Steele, Franklin, IN (US)

(21) Appl. No.: 18/334,900

(22) Filed: Jun. 14, 2023

Related U.S. Application Data
(60) Provisional application No. 63/354,190, filed on Jun. 21, 2022.

(51) Int. Cl. F02M 61/14; F02M 61/18

(52) U.S. Cl. CPC F02M 61/14; F02M 61/18

(57) ABSTRACT

Fuel injecting apparatus and methods are disclosed having components configured to provide a desired radial orientation of nozzle spray holes. Alignment rings for coupling fuel injector components include a ring body that includes a plurality of alignment guides configured to be received by complementary alignment features in the fuel injector components so as to align the fuel injector components in a desired orientation relative to each other. The plurality of alignment guides includes a primary alignment guide and at least one secondary alignment guide that is different from the primary alignment guide and each alignment guide in the plurality of alignment guides is equally spaced apart about the inner sidewall surface.

### CROSS-REFERENCE TO RELATED APPLICATION

The present application claims the benefit of the filing date of U.S. Provisional App. Ser. No. 63/354,190 filed Jun. 21, 2022, which is incorporated herein by reference in its entirety.

### TECHNICAL FIELD

The present invention generally relates to fuel injectors and more particularly to fuel injectors having components configured to provide radial orientation of nozzle spray holes.

### BACKGROUND

Known fuel injectors are generally electrically actuated devices coupled to a fuel source and configured to deliver metered quantities of fuel to combustion chambers of an internal combustion engine. In certain applications, a fuel injector includes a tip with nozzle spray holes that extends into the combustion chamber. The spray holes are spaced apart at the nozzle tip to deliver a desired spray pattern of fuel. There are benefits to precisely aligning the spray holes within the combustion chamber to achieve the desired spray pattern, such as improved fuel efficiency and reduced emissions.

Conventionally, when a fuel injector nozzle including the tip is connected to a fuel injector body, the orientation of the spray holes relative to the body (and therefore relative to the combustion chamber when the fuel injector is installed) can be difficult to control. Large fixtures may be needed in combination with one or more cameras to align the spray holes to achieve a particular spray pattern. Such an approach can be time consuming and costly and may not be suitable for use in a high-volume production environment.

### SUMMARY

One general aspect of the present disclosure includes an alignment ring for coupling fuel injector components. The alignment ring includes a ring body that includes an upstream ring end, a downstream ring end, and a sidewall extending between the upstream and downstream ring ends such that the sidewall includes an outer sidewall surface and an inner sidewall surface that is opposite the outer sidewall surface. The sidewall includes a plurality of alignment guides configured to be received by complementary alignment features in the fuel injector components so as to align the fuel injector components in a desired orientation relative to each other. The plurality of alignment guides includes a primary alignment guide and at least one secondary alignment guide that is different from the primary alignment guide and each alignment guide in the plurality of alignment guides is equally spaced apart about the inner sidewall surface. Implementations of the described techniques may include hardware, a method or process, or computer software on a computer-accessible medium.

Implementations may include one or more of the following features. The alignment ring is configured to facilitate a sealing engagement between fuel injector components. The alignment ring has at least one secondary alignment guide that optionally includes a single secondary alignment guide that is radially spaced apart from the primary alignment guide by approximately 180 degrees about the inner sidewall surface. The primary alignment guide optionally has a different form factor than the secondary alignment guides. The primary alignment guide optionally has a different width than the secondary alignment guides. The primary alignment guide optionally has a different shape than the secondary alignment guides. The plurality of alignment guides includes at least four alignment guides formed as protrusions from the inner sidewall surface. The at least one secondary alignment guide may include five secondary alignment guides such that the plurality of alignment guides are radially spaced apart by approximately 60 degrees about the inner sidewall surface. Each alignment guide in the plurality of alignment guides is optionally chamfered at one or more of the upstream and downstream ring ends so as to facilitate installation of the alignment ring. Other examples of this aspect include corresponding systems, apparatus, and methods related to these features.

Another general aspect includes a nozzle assembly for a fuel injector. The nozzle assembly includes a nozzle that is configured to be in sealing engagement with a fuel injector body. The nozzle includes a plurality of spray holes, a downstream nozzle end, and an upstream nozzle end. An alignment ring couples the nozzle to the fuel injector body. The alignment ring includes a ring body that includes an upstream ring end, a downstream ring end, and a sidewall extending between the upstream and downstream ring ends such that the sidewall includes an outer sidewall surface and an inner sidewall surface that is opposite the outer sidewall surface. The sidewall includes a plurality of alignment guides configured to be received by complementary alignment features in both the nozzle and the fuel injector body so as to align the nozzle to the fuel injector body in a desired orientation relative to each other. The plurality of alignment guides includes a primary alignment guide and at least one secondary alignment guide that is different from the primary alignment guide. Each alignment guide in the plurality of alignment guides is equally spaced apart about the inner sidewall surface. Implementations of the described techniques may include hardware, a method or process, or computer software on a computer-accessible medium.

Implementations may include one or more of the following features. The nozzle assembly has a nozzle that includes a plurality of nozzle alignment features formed as a plurality of nozzle recesses formed into an external surface of the nozzle. The plurality of nozzle alignment features optionally corresponds to a plurality of body alignment features in the fuel injector body. The plurality of nozzle recesses optionally are grooves. Each of the grooves in the nozzle optionally has one end adjacent a sealing surface at the downstream nozzle end. The plurality of alignment guides optionally are splines formed on an interior surface of the alignment ring. Each of the grooves in the nozzle optionally extends an entire length of the external surface of the nozzle such that the alignment ring can be fitted over the downstream nozzle end to couple the nozzle to the injector body. Each of the grooves in the nozzle optionally terminates short of an entire length of the external surface of the nozzle such that the alignment ring can be sandwiched between the upstream nozzle end and a downstream injector body end of the injector body. The nozzle assembly optionally includes a nozzle retainer being removably securable to the injector body and having an interior volume that receives a portion of the injector body, the alignment ring, and a portion of the nozzle. Other examples of this aspect include corresponding systems, apparatus, and methods related to these features.

One general aspect includes a method of assembling a nozzle assembly on a fuel injector with a fuel injector body that has upstream and downstream injector body ends. The method includes a nozzle with an upstream nozzle end and a downstream nozzle end, and an alignment ring with a plurality of alignment features that includes a primary alignment guide and at least one secondary alignment guide that is different from the primary alignment guide and each alignment guide in the plurality of alignment guides is equally spaced apart about an inner sidewall surface of the alignment ring. The method includes positioning the upstream nozzle end in a position that is proximate to or in contact with the downstream injector body end of the fuel injector, and coupling the nozzle to the fuel injector in a desired orientation as facilitated by the plurality of alignment features of the alignment ring disallowing undesired orientations. Implementations of the described techniques may include hardware, a method or process, or computer software on a computer-accessible medium.

Implementations may include one or more of the following features. Coupling the nozzle to the fuel injector in the desired orientation optionally includes positioning nozzle spray holes of the nozzle relative to the fuel injector body such that injector spray through the nozzle spray holes avoids obstructions or has a desired directionality when the fuel injector is operatively installed on an engine. Coupling the nozzle to the fuel injector optionally includes forming a sealing interface between the injector body and the nozzle. The method optionally includes placing a nozzle retainer over the nozzle, the alignment ring, and the injector body such that a portion of the nozzle having spray holes extends through an opening in the nozzle retainer. Placing the nozzle retainer optionally includes threading the nozzle retainer onto threads formed on an exterior surface of the injector body. Other examples of this aspect include corresponding systems, apparatus, and methods related to these features.

While multiple examples are disclosed, still other examples of the present invention will become apparent to those skilled in the art from the following detailed description, which shows and describes illustrative examples of the invention. Accordingly, the drawings and detailed description are to be regarded as illustrative in nature and not restrictive.

### BRIEF DESCRIPTION OF THE DRAWINGS

FIG. 1 is a schematic illustration of an internal combustion engine system having a fuel flow control unit and a fuel system control unit according to principles of the present disclosure;

FIG. 2A is a cross-sectional view of a fuel injector according to principles of the present disclosure;

FIG. 2B is a close-up view of a portion of FIG. 2A;

FIG. 3 is a perspective view of assembled fuel injector components according to principles of the present disclosure;

FIG. 4 is a perspective view of a fuel injector body in FIG. 3;

FIG. 5 is a perspective view of a nozzle in FIG. 3;

FIG. 6 is a perspective view of an alignment ring in FIG. 3;

FIG. 7 is a close-up exploded perspective view of fuel injector components according to principles of the present disclosure;

FIG. 8 is an end view of a fuel injector body in FIG. 7;

FIG. 9 is an end view of a nozzle in FIG. 7;

FIG. 10 is an end view of an alignment ring in FIG. 7;

FIG. 11 is a perspective view of fuel injector components according to principles of the present disclosure;

FIG. 12 is a close-up exploded perspective view of the fuel injector components in FIG. 11;

FIG. 13 is an end view of a fuel injector body in FIG. 11;

FIG. 14 is an end view of an alignment ring in FIG. 11;

FIG. 15 is an end view of a nozzle in FIG. 11;

FIG. 16 is an end view of another embodiment fuel injector body;

FIG. 17 is an end view of another embodiment alignment ring for the fuel injector body of FIG. 16;

FIG. 18 is an end view of another embodiment nozzle for the end ring of FIG. 17; and

FIG. 19 is a flowchart of a method of assembling a fuel injector according to principles of the present disclosure.

While the invention is amenable to various modifications and alternative forms, specific examples have been shown by way of example in the drawings and are described in detail below. The intention, however, is not to limit the invention to the particular examples described. On the contrary, the invention is intended to cover all modifications, equivalents, and alternatives falling within the scope of the invention as defined by the appended claims.

### DETAILED DESCRIPTION

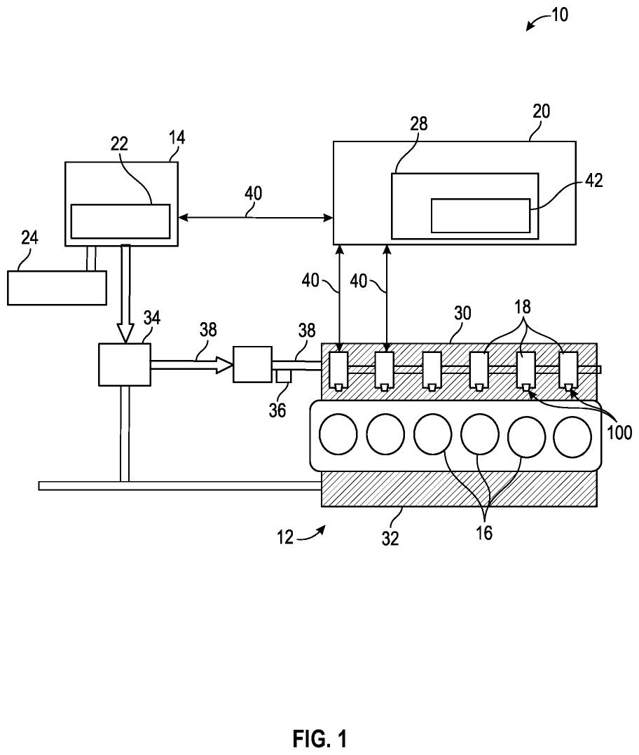

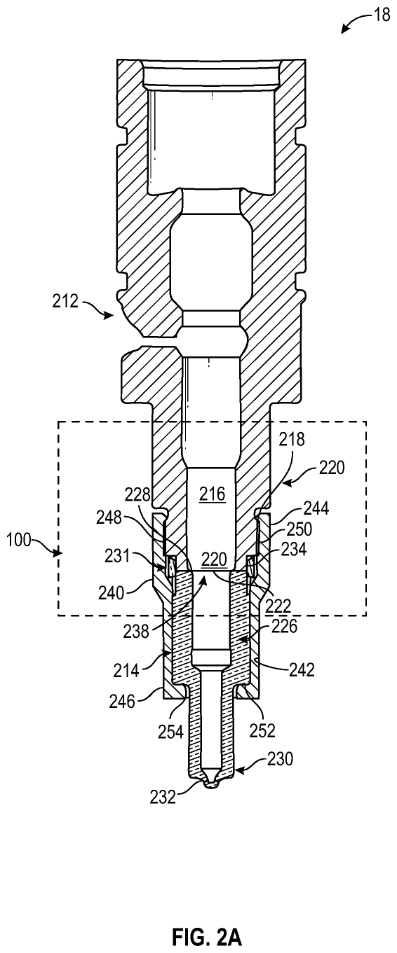

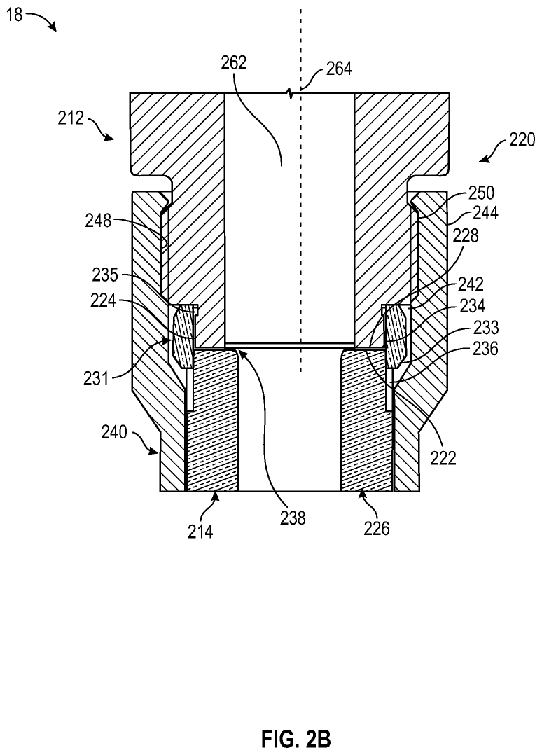

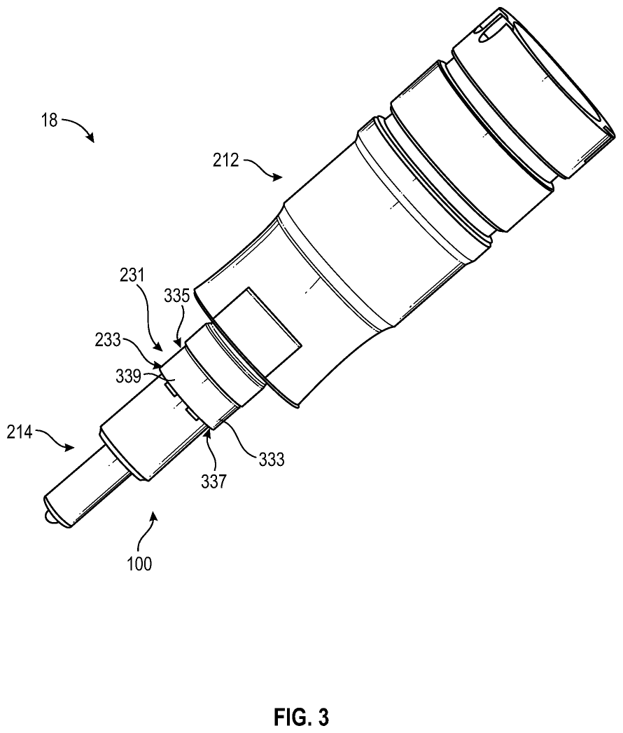

For purposes of promoting an understanding of the principles of the present disclosure, reference is now made to the examples illustrated in the drawings, which are described below. For purposes of this disclosure, like reference numerals in the figures shall refer to like features unless otherwise indicated. For example, reference numeral 100 refers to a nozzle assembly in FIG. 1 and also refers to a nozzle assembly in FIGS. 2A and 3 and so throughout.

The present disclosure generally relates to fuel injector designs and design parameters that ensure proper assembly of the fuel injector. In this regard, among other things, the present disclosure provides devices, systems, and methods to reliably radially orient nozzle spray holes of the fuel injector in a desired orientation. Under these circumstances, assembly of the fuel injector in other, undesired orientations can be inhibited.

For instance, an alignment ring can act as a coupler to provide both a sealing engagement in the fuel injector and a clocking arrangement that allows for one (or more) desired orientations of the nozzle spray holes when coupled. Advantageously, these desired orientations precisely align nozzle spray holes within associated combustion chambers in engine cylinders. In this way, fuel spray through the nozzle spray holes can avoid obstructions in the engine cylinders, direct spray into accommodating portions of associated piston bowls within the engine cylinders, and the like. When compared to known fuel injectors, these fuel injector designs and related principles of the present disclosure can achieve improved fuel efficiency and reduced emissions.

A fuel injector incorporating such an alignment ring can be configured such that when the nozzle is connected to the body, the spray holes are automatically positioned in a desired orientation relative to the body and the combustion chamber. More details about these fuel injectors are discussed below, starting with discussion of an example implementation of an engine employing one or more of these fuel injectors.

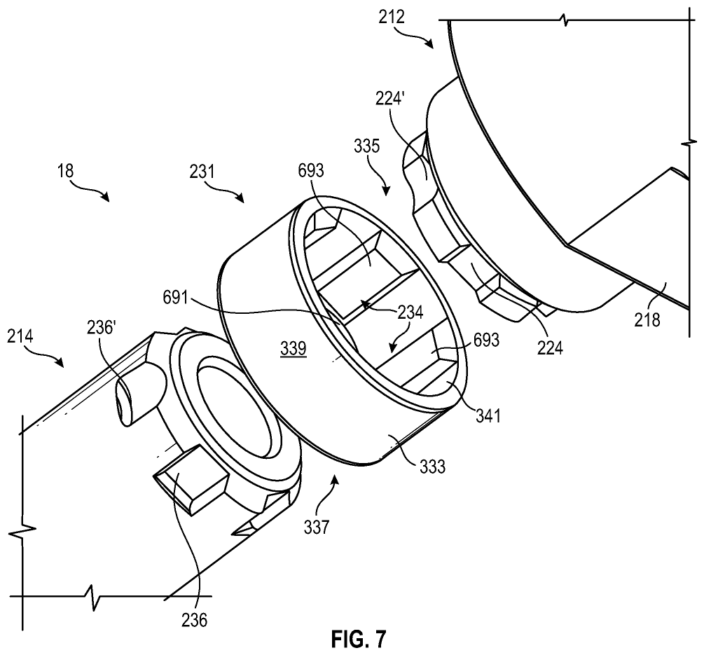

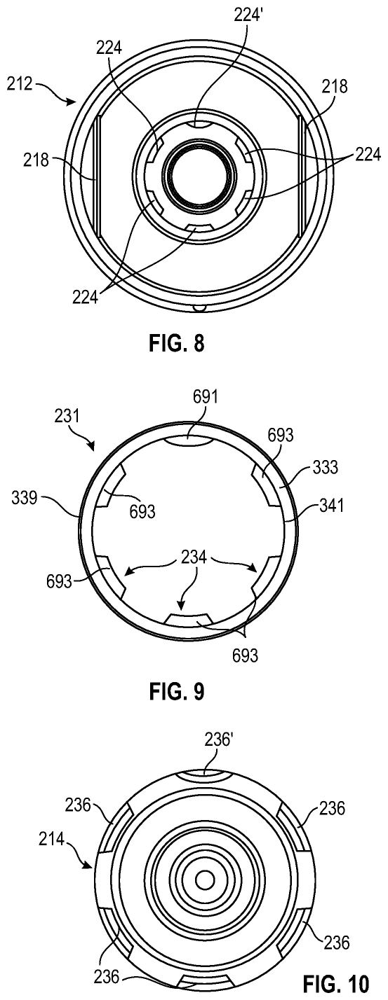

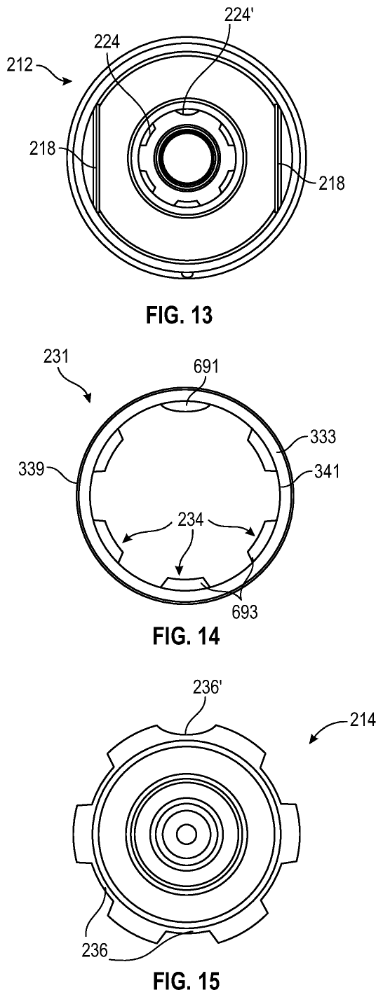

Referring to FIGS. 2A-18, in an embodiment, an alignment ring 231 for coupling fuel injector components 212, 214 is provided. The alignment ring 231 includes a ring body 233 that includes an upstream ring end 335, a downstream ring end 337, and a sidewall 233 extending between the upstream and downstream ring ends 335, 337. The sidewall 233 includes an outer sidewall surface 339 and an inner sidewall surface 341 that is opposite the outer sidewall surface 339. The sidewall 233 further includes a plurality of alignment guides 234 configured to be received by complementary alignment features 224, 236 in the fuel injector components 212, 214 so as to align the fuel injector components 212, 214 in a desired orientation relative to each other. The plurality of alignment guides 234 includes a primary alignment guide 691 and at least one secondary alignment guide 693 that is different from the primary alignment guide 691, and each alignment guide 234 in the plurality of alignment guides 234 is equally spaced apart about the inner sidewall surface 341.

In an embodiment, a nozzle assembly 100 is provided for a fuel injector 18. The nozzle assembly 100 includes a nozzle 214 that is configured to be in sealing engagement with a fuel injector body 212. The nozzle 214 includes a plurality of spray holes 232, a downstream nozzle end 214a, and an upstream nozzle end 214b. An alignment ring 231 couples the nozzle 214 to the fuel injector body 212. The alignment ring 231 includes ring body 233 that includes upstream ring end 335, downstream ring end 337, and sidewall 233 extending between the upstream and downstream ring ends 335, 337 such that the sidewall 233 includes outer sidewall surface 339 and inner sidewall surface 341 that is opposite the outer sidewall surface 339. The sidewall 233 further includes the plurality of alignment guides 234 configured to be received by complementary alignment features 224, 236 in both the injector body 212 and the nozzle 214 so as to align the injector body 212 to the nozzle 214 in a desired orientation relative to each other. The plurality of alignment guides 234 includes a primary alignment guide 691 and at least one secondary alignment guide 693 that is different from the primary alignment guide 691, and each alignment guide 234 in the plurality of alignment guides 234 is equally spaced apart about the inner sidewall surface 341.

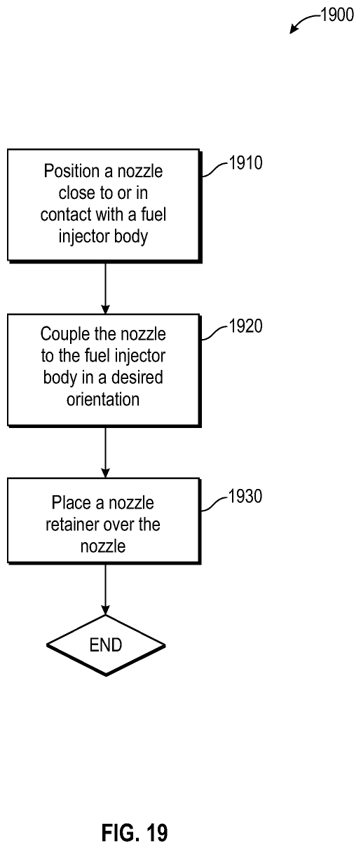

Referring further to FIG. 19, in an embodiment, a method 1900 of assembling nozzle assembly 100 on fuel injector 18 is disclosed. Fuel injector 18 includes fuel injector body 212 that has upstream and downstream injector body ends 212a, 212b. The nozzle assembly 100 includes nozzle 214 with upstream nozzle end 214a and downstream nozzle end 214b. Alignment ring 231 has a plurality of alignment guides 234, which includes a primary alignment guide 691 and at least one secondary alignment guide 693 that is different from the primary alignment guide 691, and each alignment guide 234 in the plurality of alignment guides 234 is equally spaced apart about inner sidewall surface 341 of the alignment ring 231. The method 1900 includes positioning 1910 the upstream nozzle end 214a in a position that is proximate to or in contact with the downstream injector body end 212b of the fuel injector body 112, and coupling 1920 the nozzle 214 to the fuel injector body 212 in a desired orientation as facilitated by the plurality of alignment guides 234 of the alignment ring 231 disallowing undesired orientations.

With reference to the figures, FIG. 1 shows an internal combustion engine system 10 for a vehicle (not shown) including an engine 12 and a fueling system 14. In this example, the engine 12 is a fuel injection engine 12 operated by liquid or gaseous fuel, such as gasoline, diesel, or gas (e.g., LPG) engines. Other suitable types of engines using gaseous fuels, such as liquefied hydrogen, propane, or other pressurized fuels, are also contemplated to suit different applications. In fuel injected engines, fuel is supplied to cylinders 16 in a cylinder head using one or more injectors 18 (referred to hereinafter as “injectors” and/or “fuel injectors”) in accordance with a signal provided by a controller 20. Fuel from the fuel injectors 18 combusts within a combustion chamber formed between the cylinders 16 and pistons (not shown) arranged within the cylinders 16. Although six cylinders 16 are shown in FIG. 1, any number of cylinders 16 is contemplated to suit different applications.

Illustratively, the fueling system 14 in this example includes a fuel flow control unit 22 that is configured to control a fuel flow and an amount of fuel supplied from a fuel tank 24 to injectors 18. The engine 12 includes an intake manifold 30 that receives fuel from the fuel tank 24 via the injectors 18, the cylinders 16 in which to combust fuel, and an exhaust manifold 32 that receives combustion gases from the cylinders 16 and supplies the combusted gases to a charging subsystem 34 (e.g., a charge pump) as desired. In this example, a fuel rail pressure sensor 36 monitors a pressure level in an inlet fuel rail 38 and reports a pressure reading to an engine control unit 28 (referred to hereinafter as “ECU”). A location of the fuel rail pressure sensor 36 varies depending on applications, and the location can be any suitable position along the inlet fuel rail 38 between the fuel tank 24 and the engine 12. For example, the fuel rail pressure sensor 36 is attached to the inlet fuel rail 38 to generate a fuel rail pressure signal for feedback control of fuel rail pressure by the ECU 28.

In FIG. 1, the controller 20 includes the ECU 28, which is operable to produce control signals on one or more of signal paths 40. The controller 20 thereby controls the operation of one or more corresponding suitably positioned engine components, such as the fueling system 14. For example, the ECU 28 controls directly each of the injectors 18 via the signal paths 40. For each of the injectors 18, the ECU 28 generates a drive current that has a duration equal to a desired on-time, and the start of the current command is associated with a desired start of injection (i.e., injection timing). One or more engine systems related to an engine load, such as engine torque or horsepower, and other engine parameters, such as an engine speed or revolution per minute (RPM), are also controlled by the ECU 28 for regulating operation of the engine system 10. Optionally, the ECU 28 is in communication with a controller area network (CAN) or other serial bus systems for communicating with various components and sensors on the engine 12 and/or within the vehicle.

The ECU 28 includes a fuel system control unit 42 that is configured to control a fuel pressure applied to one or more of the injectors 18 during a motoring condition period based on a commanded pulse train duration. In examples, fuel system control unit 42 controls not only the fuel pressure (e.g., by manipulating the fuel flow control unit 22), but also controls a quantity and timing of fuel injected into each cylinder 16. The motoring condition period refers to a predetermined time period during which the motoring condition persists, e.g., no fuel is delivered to the cylinders 16 and no combustion occurs in the cylinders 16 of the engine 12. The commanded pulse train duration refers to a time period during which one or more injectors 18 are repeatedly activated for a drain operation. More details about the fuel injectors 18 and related components, especially as it pertains to connect nozzle assemblies 100, are discussed here below.

FIGS. 2A and 2B depict a fuel injector 18 that includes a nozzle assembly 100 aligned according to principles of the present disclosure. In particular, FIG. 2A is a side, cross-sectional view of a fuel injector 18 with a nozzle assembly 100 in a fully assembled state, according to principles of the present disclosure. FIG. 2B is a side, cross-sectional view of a portion of FIG. 2A.

As shown, the fuel injector 18 is fluidly coupled to the nozzle assembly 100. Illustratively, the fuel injector 18 generally includes a body 212 (sometimes referred to herein as a fuel injector body 212). The fuel injector body 212 includes an upper body portion 216 having at least one flange 218 and a body lower portion 220 having a body sealing surface 222 with a plurality of body alignment features 224 (here, body recesses or body grooves 224 as best seen in FIG. 2B) formed therein. The fuel injector body 212 is connected to a nozzle 214 in the nozzle assembly 100. Illustratively, the nozzle 214 includes a nozzle upper portion 226 with a nozzle sealing surface 228 having a plurality of nozzle alignment features 236 (here, nozzle recesses or nozzle grooves 236 as best seen in FIG. 2B) formed therein. The nozzle 214 also includes a nozzle lower portion 230 having a plurality of spray holes or nozzle holes 232.

Orientation of the nozzle 214 relative to the fuel injector body 212 can be influenced by an alignment ring 231 with alignment guides 234 that are complementary to each plurality of alignment features. Illustratively, as best seen in FIG. 2B, the alignment ring 231 has substantially cylindrical side wall 233 defining a central opening 235. The alignment ring 231 includes a plurality of alignment guides 234 (here, protrusions 234 or splines 234) sized to fit within the body alignment features 224 and corresponding the nozzle alignment features 236.

As is described below, the precise orientation of the fuel injector body 212 and nozzle 214 alignment features 224, 236 relative to the flange 218 and use of the alignment guides 234 results in a precise orientation of the nozzle 214 (and the nozzle holes 232) relative to the flange 218. As the flange 218 is formed to orient the fuel injector 18 in an injector bore (not shown) of a cylinder head, and therefore relative to the combustion chamber, the precise orientation of the nozzle holes 232 relative to the flange 218 results in precise orientation of the nozzle holes 232 relative to the combustion chamber. It should be understood that other features of the fuel injector body 212 may be used as a reference for alignment of the nozzle holes 232 such as a high-pressure hole in the fuel injector body 212.

When assembled, as shown in FIGS. 2A and 2B, the nozzle 214 is coupled to the fuel injector body 212 such that the body grooves 224 are aligned with the nozzle grooves 236. This alignment of the body grooves 224 with the nozzle grooves 236 is fixed by installation of the alignment ring 231 when the alignment guides 234 of the alignment ring 231 are received into the fuel injector body 212 and nozzle 214 grooves 224, 236. As such, the alignment guides 234 provide splines to align the nozzle 214 relative to the fuel injector body 212, thereby aligning the nozzle holes 232 relative to the flange 218 (and ultimately relative to the combustion chamber).

Additionally, when the nozzle 214 is coupled to the fuel injector body 212, the nozzle sealing surface 228 engages the body sealing surface 222, thereby forming a sealing interface 238. This sealing interface 238 can inhibit fuel from escaping from the central fuel chamber 262 of the fuel injector 18 during operation. In examples, it is possible for the alignment ring 231 to be press fit (e.g., with the fuel injector body 212 and/or the nozzle 214). In some such examples, the alignment ring 231 may seal assist in forming the sealing interface 238 (e.g., between the nozzle sealing surface 228, body sealing surface 222, and the alignment ring 231 with the nozzle sealing surface 228 and the body sealing surface 222 just out of contact or otherwise spaced apart from each other). Further, the alignment ring 231 can be a sacrificial component that has a softer material than that of the nozzle 214 and fuel injector body 212.

According to principles of the present disclosure, a sealing engagement is achievable when the fuel injector body 212 and the nozzle 214 are coupled. When the nozzle 214 is coupled to the fuel injector body 212, the alignment guides 234 extend into the body alignment features 224 and into the nozzle alignment features 236. As such, the alignment guides 234 align the nozzle 214 relative to the fuel injector body 212, thereby aligning the nozzle holes 232 relative to the flange 218 (and ultimately relative to the combustion chamber). When the nozzle 214 is coupled to the fuel injector body 212, the nozzle sealing surface 228 engages the body sealing surface 222, thereby forming a sealing interface 238. This sealing interface 238 can inhibit fuel from escaping from the central fuel chamber 262 of the fuel injector 18 during operation. Still, the alignment ring 231 can have a free-floating fit when installed or, optionally, can have a snug fit depending on the application.

With continued reference to FIGS. 2A-2B, the nozzle assembly 100 optionally includes a nozzle retainer 240 that is configured to retain the nozzle sealing surface 228 in contact with the body sealing surface 222. The nozzle retainer 240 includes a retainer central opening 242, a retainer upper end 244, and a retainer lower end 246. In this example, the retainer upper end 244 includes internal retainer threads 248 that mesh with external body threads 250 formed on an external surface of the lower portion 220 of the fuel injector body 212. The engagement of the retainer threads 248 with the body threads 250 connects the nozzle retainer 240 to the fuel injector body 212.

The retainer lower end 246 of the nozzle retainer 240 includes a shoulder 252 and a nozzle opening 254. The shoulder 252 engages the nozzle upper portion 226 of the nozzle 214 when the retainer threads 248 are threaded onto the body threads 250 and urges the nozzle 214 upwardly into engagement with the fuel injector body 212 to form the sealing interface 238. The nozzle lower portion 230 extends through the nozzle opening 254 of the nozzle retainer 240. Illustratively, each of the nozzle 214, the fuel injector body 212, the alignment ring 231, and nozzle retainer 240 are substantially aligned along a central longitudinal axis 264. As shown here, the alignment ring 231 can be sized such that the nozzle retainer 240 is easily able to fit over the alignment ring 231 without interfering with the retainer threads 248. Though discussed in terms of threaded engagement, other types of mechanical engagements known in the art are also contemplated and are therefore well within the scope of the present disclosure.

A variety of advantages results from employing principles of the present disclosure. For instance, use of external body and nozzle grooves 224, 236 and internal alignment guides 234 to align the nozzle 214 relative to the fuel injector body 212 provides an increased surface area of the sealing interface 238 (relative to sealing interface 238) adjacent the locations of the body and nozzle grooves 224, 236. The nozzle sealing surface 228 provides a large surface area at the sealing interface 238 in the location of the alignment guides 234 between the fuel chamber 262 and the grooves 224 of the lower portion 220. This may improve the efficacy of the sealing interface 238 relative to known designs. Moreover, under high loads (such as when nozzle retainer 240 is threaded onto fuel injector body 212) rotational torque applied to alignment guides 234 may cause them to strip or round off, but not impact the integrity of sealing interface 238. Moreover, alignment ring 231 (unlike discrete pins, adhesives, or other known couplers) is unlikely to be unknowingly assembled incorrectly, prematurely worn, or lost.

It should be further understood that more than two body and nozzle grooves 224, 236 and more than two corresponding alignment guides 234 may be used. More body and nozzle grooves 224, 236 and alignment guides 234 may provide nozzle 214 orientation adjustability to achieve different desired spray patterns of nozzle holes 232. While illustrated as having the same number of body and nozzle grooves 224, 236 and alignment guides 234, the number of body and nozzle grooves 224, 236 may not correspond to the number of alignment guides 234 in examples. Additionally, the body grooves 224 and nozzle grooves 236 may be formed in certain examples using broaching or wobble broaching, which is a relatively inexpensive, quick process compared to forming very high accuracy, true positioned alignment features in known fuel injectors. Still more, the alignment guides 234 of the alignment ring 231 may be formed using broaching or by forming a complete sintered metal part, which are relatively inexpensive processes. In such an example, the alignment guides 234 may be formed as splines before hardening the alignment ring 231.

To that end, the following figures show variations that can be made to the fuel injectors 18 discussed above. In particular, these figures show alignment rings with varying numbers and form factors of alignment guides 234 therein. In addition, these figures show variations made to the alignment features in the nozzle 214 and the fuel injector body 212. These illustrated examples are just some of the many examples disclosed herein and should not be narrowly construed.

FIGS. 3-18 show various design variations that can be made to the fuel injector components discussed herein. These fuel injector components are similar to those discussed elsewhere herein, including those for the fuel injectors 18. As such included therein are a fuel injector body 212 with at least one flange 218 and a plurality of alignment features 224; an alignment ring 231 with a plurality of alignment guides 234; and a nozzle assembly 100 with a nozzle 214 having a plurality of alignment features 236 and nozzle spray holes 232.

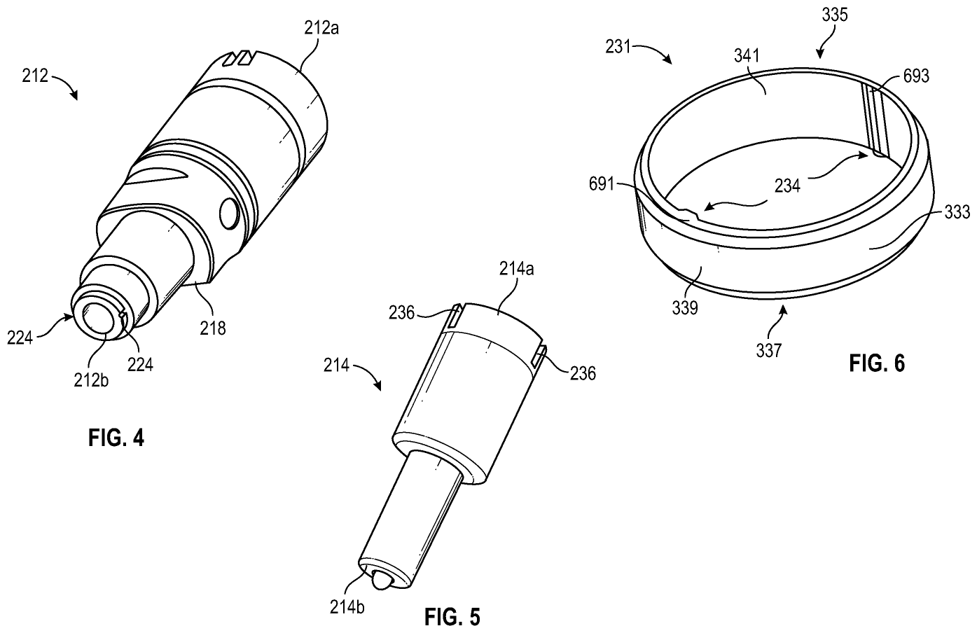

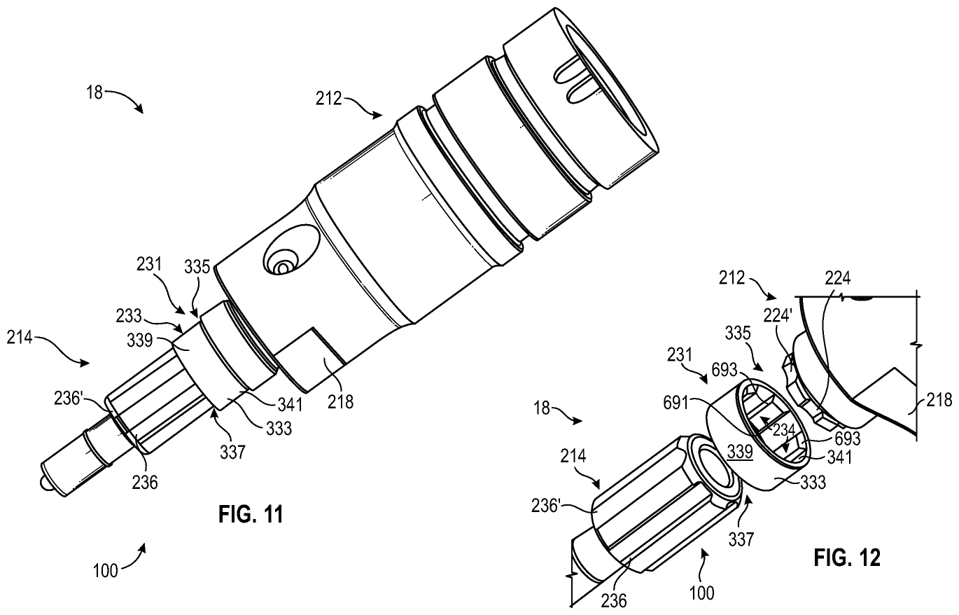

In particular, FIGS. 3-10 show examples where the fuel injector components include a nozzle 214 with terminating nozzle grooves 236 as well as an alignment ring 231 with a pair of spline-shaped alignment guides 234 (FIGS. 4-6) or optionally six spline-shaped alignment guides 234 (FIGS. 7-10). FIGS. 11-18 show examples where the fuel injector components include a nozzle 214 with non-terminating, through nozzle grooves 236 as well as an alignment ring 231 with six spline-shaped alignment guides 234 with a single, differently shaped primary alignment guide 691 (FIGS. 11-14) or a single, differently dimensioned primary alignment guide 691 (FIGS. 15-18). For instance, there may be one rounded primary alignment guide 691 among one or more non-rounded secondary alignment guides 693 (see e.g., FIGS. 11-14) or one primary alignment guide 691 that is wider and/or taller than other secondary alignment guides 693 (see e.g., FIGS. 15-18).

While not explicitly illustrated here, there are contemplated alignment ring designs where more than one alignment guide 234 is different than the other alignment guides 234 and, in fact, where two or more unique alignment guides 234 (e.g., one differently shaped and the other differently dimensioned) are employed as primary alignment guides. This feature may be useful if a desired orientation is symmetrical rather than asymmetrical.

Notably, as discussed above, the plurality of alignment guides 234 is provided by an alignment ring 231 that is configured to couple fuel injector components. Namely, the alignment ring 231 is shown coupling the fuel injector body 212 and the nozzle 214. The alignment ring 231 illustratively includes a ring body 333 that has an upstream ring end 335, a downstream ring end 337, and a sidewall 233 extending between the upstream and downstream ring ends 335, 337. The upstream and downstream ring ends 335, 337 are opposing ends of the alignment ring 231. In this regard, the sidewall 233 includes an outer sidewall surface 339 and an inner sidewall surface 341 that is opposite the outer sidewall surface 339.

The sidewall 233 further includes a plurality of alignment guides 234 that is configured to be received by complementary alignment features (e.g., body and nozzle alignment features 224, 236) in the fuel injector components. Under these circumstances, alignment of the fuel injector components in a desired orientation relative to each other is achievable. For instance, each alignment guide 234 in the plurality of alignment guides 234 is equally spaced apart about the inner sidewall surface 341. In examples, the primary alignment guide 691 is different from the secondary alignment guides 693. In addition, or in alternative, each alignment guide 234 in the plurality of alignment guides 234 can be chamfered at one or more of the upstream and downstream ring ends 335, 337 so as to facilitate installation of the alignment ring 231.

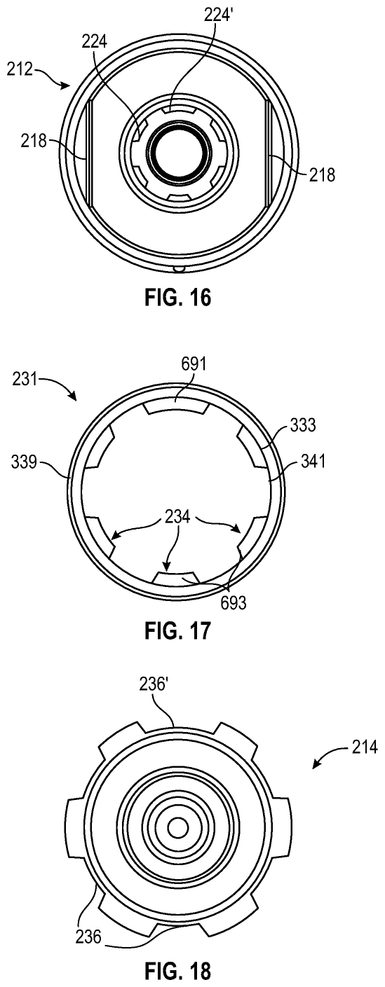

In this regard, the primary alignment guide 691 has a different form factor than the secondary alignment guides 693. For instance, in an example, the primary alignment guide 691 has a different width than the secondary alignment guides 693, as shown in FIG. 17. As a result, one of the alignment features 224′, 236′ in body 212 and nozzle 214 has a different width than the other alignment features 224, 236 to accept the primary alignment guide 691, as shown in FIGS. 16 and 18. The primary alignment guide 691 is thus too large to be positioned in another of the other alignment features 224, 236, and only the secondary alignments guides 693 can be so positioned in the other alignment features 224, 236.

For instance, in another example, the primary alignment guide 691 has a different shape than the secondary alignment guides 693, as shown in FIGS. 9 and 14. As a result, one of the alignment features 224′, 236′ in injector body 212 and nozzle 214 has a different shape than the other alignment features 224, 236 to accept the primary alignment guide 691, and the primary alignment guide 691 is not positionable in another of the other alignment features 224, 236. The shape of primary alignment guide 691 does not allow it to be positioned in another of the other alignment features 224, 236, only the secondary alignments guides 693 can be so positioned in the other alignment features 224, 236.

In an embodiment, the shape of primary alignment guide 691 is a convexly curved shape protruding outwardly from inner sidewall surface 341, and the secondary alignment guide(s) 693 include a rectangular or polygonal shape with at least two linear sides protruding outwardly from inner sidewall surface 341. An opposite configuration is also possible, with primary alignment guide 691 having linear protruding sides and secondary alignment guides 693 having a convex shape.

In an embodiment, the size of primary alignment guide 691 is larger in width along and/or protruding outwardly from inner sidewall surface 341 than the secondary alignment guide(s) 693. An opposite configuration is also possible, with primary alignment guide 691 having a smaller width and/or size than secondary alignment guides 693.

In an embodiment, the primary alignment guide 691 is keyed to the alignment features 224′, 236′ of injector body 212 and nozzle 214. Examples include a tongue-and-groove, dovetail, and other keyed type connection arrangements.

In examples, the alignment ring 231 is configured to facilitate a sealing engagement between the fuel injector components. In examples, the plurality of alignment guides 234 may include first and second alignment guides 234 that are radially spaced apart by 180 degrees about the inner sidewall surface 341. The plurality of alignment guides 234 includes at least four alignment guides 234 formed as protrusions 234 from the inner sidewall surface 341. In examples, the plurality of alignment guides 234 may include of six alignment guides 234 that are radially spaced apart by approximately 60 degrees about the inner sidewall surface 341.

Various methods related to the fuel injectors discussed elsewhere herein are also disclosed and will now be discussed. As shown in FIG. 19, one general aspect includes a method 1900 of assembling a nozzle assembly on a fuel injector. The fuel injector includes a fuel injector body 212 that has upstream and downstream injector body ends 212a, 212b. At step 1910, the method 1900 includes positioning an upstream nozzle end 214a of the nozzle 214 in a position that is proximate to or in contact with the downstream injector body end 212b of the fuel injector body 212. At step 1920, the method 1900 includes coupling the nozzle 214 to the fuel injector body 212 in a desired orientation as facilitated by the plurality of alignment features 234 of the alignment ring 231 disallowing undesired orientations, as discussed above. Other examples of this aspect include corresponding systems and apparatus, each of which is configured to perform the actions of the methods. More details about one or more of these method steps are discussed below.

Implementations of the method 1900 may include one or more of the following features. Coupling the nozzle 214 to the fuel injector in the desired orientation at step 1910 can include positioning nozzle spray holes 232 of the nozzle 214 relative to the fuel injector body 212 such that injector spray through the nozzle spray holes 232 avoids obstructions or has a desired directionality when the fuel injector is operatively installed on an engine. As noted above, where the nozzle 214 includes terminating grooves, the alignment ring 231 can be first installed on the nozzle 214 or fuel injector body 212 and subsequently sandwiched between these two components. Additionally, or in alternative, when the nozzle 214 includes alignment features 236 in the form of through grooves, the nozzle 214 and fuel injector body 212 can be positioned to align their respective grooves to match the corresponding alignment guides 234 in the alignment ring 231, and the alignment ring 231 can be fitted over the downstream nozzle end into position.

Coupling the nozzle to the fuel injector at step 1910 can include forming a sealing interface between the injector body 212 and the nozzle 214. Where a nozzle retainer 240 is desired, at step 1930, the method 1900 can include placing the nozzle retainer 240 over the nozzle 214, the alignment ring 231, and the injector body 212 such that a portion of the nozzle 214 having spray holes 232 extends through an opening in the nozzle retainer 240. Placing the nozzle retainer 240 can include threading the nozzle retainer 240 onto threads formed on an exterior surface of the injector body 212. Other variations to the method steps will be apparent from the above discussion regarding fuel injector apparatus and systems.

A practical example of the method 1900 will now be discussed. The alignment ring 231 is first placed onto the body lower portion such that alignment guides 234, such as splines, of alignment ring 231 are received by the correspondingly configured alignment features 224, such as grooves, of the lower portion. Next, the nozzle 214 is placed into the alignment ring 231 such that alignment features 236, such as grooves, of an upper nozzle portion receive the correspondingly configured alignment guides 234 of the alignment ring 231. The nozzle 214 is thus positioned to engage the injector body 212 in a predetermined nozzle clocking interface and form a sealing interface. Then the nozzle retainer 240 is placed over the nozzle 214, the alignment ring 231, and the body lower portion of injector body 212 such that the lower nozzle portion (including nozzle holes 231) extends through an opening of the nozzle retainer 240. The nozzle retainer 240 is then threaded onto the body lower portion of injector body 212 in the manner described above to connect the nozzle retainer 240 to the injector body 212 and urge the nozzle 214 into engagement with the injector body 212 to thereby facilitate retention of the sealing interface.

In view of the above discussion, it becomes apparent to one skilled in the art that the present disclosure provides an efficient and effective way to assemble nozzles to injectors while maintaining a pre-determined nozzle clocking arrangement or orientation in relation to the injector body (and ultimately within the engine cylinder head, and piston bowl) for optimum combustion efficiency. In addition, the present disclosure will work for nozzle spray holes that are symmetrical and spray holes that are asymmetrical in geometry & spacing.

The illustrated examples disclosed herein are not intended to be exhaustive or to limit the disclosure to the precise form disclosed in the following detailed description. Rather, these exemplary examples were chosen and described so that others skilled in the art may use their teachings. It is not beyond the scope of this disclosure to have a number (e.g., all) the features in a given example used across all examples. Thus, no one figure should be interpreted as having any dependency or requirement related to any single component or combination of components illustrated therein. Additionally, various components depicted in a given figure may be, in examples, integrated with various ones of the other components depicted therein (and/or components not illustrated), all of which are considered to be within the ambit of the present disclosure.

As used herein, the term “upstream” and “upper” generally means in the direction toward or most proximate to fuel flow from a fuel source, whereas “downstream” and “lower” generally means an opposite direction toward an engine, with respect to fuel flow through the respective component.

Throughout the present disclosure and in the claims, numeric terminology, such as first and second, is used in reference to various components or features. Such use is not intended to denote an ordering of the components or features. Rather, numeric terminology is used to assist the reader in identifying the component or features being referenced and should not be narrowly interpreted as providing a specific order of components or features.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps may be added or omitted without departing from the scope of this disclosure. Such steps may include incorporating devices, systems, or methods or components thereof as well as what is well understood, routine, and conventional in the art.

The terms “substantially,” “approximately,” “about,” and similar terms are intended to have a broad meaning in harmony with the common and accepted usage by those of ordinary skill in the art to which the subject matter of this disclosure pertains. Indeed, these terms are defined as being largely but not necessarily wholly what is specified (and include wholly what is specified) as understood by one of ordinary skill in the art. In any disclosed example, the term “substantially,” “approximately,” or “about” may be substituted with “within [a percentage] of” what is specified, where the percentage includes 0.1, 1, 5, and 10 percent.

The terms “fluidly coupled,” “in fluid communication,” and the like, as used herein, mean the two components or objects have a pathway formed between the two components or objects in which a fluid, such as fuel, exhaust, water, air, gaseous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another. As described herein, “preventing” should be interpreted as potentially allowing for de minimus circumvention (e.g., less than 1%) of the exhaust gases.

The connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an example, B alone may be present in an example, C alone may be present in an example, or that any combination of the elements A, B or C may be present in a single example; for example, A and B, A and C, B and C, or A and B and C.

In the detailed description herein, references to “one example,” “an example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art with the benefit of the present disclosure to affect such feature, structure, or characteristic in connection with other examples whether or not explicitly described. After reading the description, it will be apparent to one skilled in the relevant art(s) how to implement the disclosure in alternative examples.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus

While the present disclosure has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. An alignment ring for coupling fuel injector components, the alignment ring comprising:
a ring body that includes an upstream ring end, a downstream ring end, and a sidewall extending between the upstream and downstream ring ends such that the sidewall includes an outer sidewall surface and an inner sidewall surface that is opposite the outer sidewall surface, the sidewall further includes a plurality of alignment guides configured to be received by complementary alignment features in the fuel injector components so as to align the fuel injector components in a desired orientation relative to each other,
wherein the plurality of alignment guides includes a primary alignment guide and at least one secondary alignment guide that is different from the primary alignment guide and each alignment guide in the plurality of alignment guides is equally spaced apart about the inner sidewall surface.

2. The alignment ring of claim 1, wherein the at least one secondary alignment guide consists of a single secondary alignment guide that is radially spaced apart from the primary alignment guide by approximately 180 degrees about the inner sidewall surface.

3. The alignment ring of claim 1, wherein the primary alignment guide has a different form factor than the at least one secondary alignment guide.

4. The alignment ring of claim 3, wherein the primary alignment guide has a different width than the at least one secondary alignment guide.

5. The alignment ring of claim 3, wherein the primary alignment guide has a different shape than the at least one secondary alignment guide.

6. The alignment ring of claim 1, wherein the alignment ring is configured to facilitate a sealing engagement between the fuel injector components.

7. The alignment ring of claim 1, wherein the plurality of alignment guides includes at least four alignment guides formed as protrusions from the inner sidewall surface.

8. The alignment ring of claim 7, wherein the at least one secondary alignment guide consists of five secondary alignment guides such that the plurality of alignment guides are radially spaced apart by approximately 60 degrees about the inner sidewall surface.

9. The alignment ring of claim 1, wherein each alignment guide in the plurality of alignment guides is chamfered at one or more of the upstream and downstream ring ends so as to facilitate installation of the alignment ring.

10. A nozzle assembly for a fuel injector, the nozzle assembly comprising:
a nozzle that is configured to be in sealing engagement with a fuel injector body, the nozzle includes a plurality of spray holes, a downstream nozzle end, and an upstream nozzle end; and
an alignment ring coupling the nozzle to the fuel injector body, the alignment ring comprising a ring body that includes an upstream ring end, a downstream ring end, and a sidewall extending between the upstream and downstream ring ends such that the sidewall includes an outer sidewall surface and an inner sidewall surface that is opposite the outer sidewall surface, the sidewall further includes a plurality of alignment guides configured to be received by complementary alignment features in both the nozzle and the fuel injector body so as to align the nozzle to the fuel injector body in a desired orientation relative to each other,
wherein the plurality of alignment guides includes a primary alignment guide and at least one secondary alignment guide that is different from the primary alignment guide and each alignment guide in the plurality of alignment guides is equally spaced apart about the inner sidewall surface.

11. The nozzle assembly of claim 10, wherein the nozzle includes a plurality of nozzle alignment features formed as a plurality of nozzle recesses in an external surface of the nozzle, the plurality of nozzle alignment features corresponding to a plurality of body alignment features in the fuel injector body.

12. The nozzle assembly of claim 11, wherein the plurality of nozzle recesses are grooves, each of the grooves in the nozzle having one end adjacent a sealing surface at the downstream nozzle end, and wherein the plurality of alignment guides are splines formed on an interior surface of the alignment ring.

13. The nozzle assembly of claim 12, wherein each of the grooves in the nozzle extends an entire length of the external surface of the nozzle, such that the alignment ring can be fitted over the downstream nozzle end to couple the nozzle to the injector body.

14. The nozzle assembly of claim 12, wherein each of the grooves in the nozzle terminates short of an entire length of the external surface of the nozzle, such that the alignment ring can be sandwiched between the upstream nozzle end and a downstream injector body end of the injector body.

15. The nozzle assembly of claim 10, further comprising a nozzle retainer being removably securable to the injector body and having an interior volume that receives a portion of the injector body, the alignment ring, and a portion of the nozzle.

16. A method of assembling a nozzle assembly on a fuel injector with a fuel injector body that has upstream and downstream injector body ends, the nozzle assembly including:
a nozzle with an upstream nozzle end and a downstream nozzle end, and
an alignment ring with a plurality of alignment guides that includes a primary alignment guide and at least one secondary alignment guide that is different from the primary alignment guide and each alignment guide in the plurality of alignment guides is equally spaced apart about an inner sidewall surface of the alignment ring;
the method comprising:
positioning the upstream nozzle end in a position that is proximate to or in contact with the downstream injector body end of the fuel injector body, and
coupling the nozzle to the fuel injector body in a desired orientation as facilitated by the plurality of alignment guides of the alignment ring disallowing undesired orientations.

17. The method of claim 16, wherein coupling the nozzle to the fuel injector in the desired orientation includes positioning nozzle spray holes of the nozzle relative to the fuel injector body such that injector spray through the nozzle spray holes avoids obstructions or has a desired directionality when the fuel injector is operatively installed on an engine.

18. The method of claim 16, wherein coupling the nozzle to the fuel injector includes forming a sealing interface between the injector body and the nozzle.

19. The method of claim 16, further comprising placing a nozzle retainer over the nozzle, the alignment ring, and the injector body such that a portion of the nozzle having spray holes extends through an opening in the nozzle retainer.

20. The method of claim 19, wherein placing the nozzle retainer includes threading the nozzle retainer onto threads formed on an exterior surface of the injector body.
